(19) United States
(12) Patent Application Publication
(10) Pub. No.: US 2015/0199094 A1
(43) Pub. Date: Jul. 16, 2015

(54) DEVICE FOR CONTROLLING A GRAPHIC USER INTERFACE

(71) Applicants: Ran ZHANG, Stuttgart (DE); Halady PRASHANTH, Koramangala (IN); Benjamin COORS, Weil der Stadt (DE)

(72) Inventors: Ran ZHANG, Stuttgart (DE); Halady PRASHANTH, Koramangala (IN); Benjamin COORS, Weil der Stadt (DE)

(73) Assignee: Robert Bosch GmbH, Stuttgart (DE)

(21) Appl. No.: 14/326,716

(22) Filed: Jul. 9, 2014

(30) Foreign Application Priority Data
Jan. 10, 2014 (DE) 10 2014 200 341.5

(51) Int. Cl. G06F 3/0484; H04L 29/08

(52) U.S. Cl. CPC G06F 3/0484; H04L 67/12

(57) ABSTRACT

A method and a device for controlling a graphic user interface of a display unit, having a first interface, having a processing unit, having a second interface, the first interface being configured to transmit a message of the user interface to the processing unit; the processing unit being configured to send the message via the second interface to at least one data source; and the second interface being configured to receive a response message from the data source; the processing unit being configured to route on the response message via the first interface to the user interface.

### RELATED APPLICATION INFORMATION

The present application claims priority to and the benefit of German patent application no. 10 2014 200 341.5, which was filed in Germany on Jan. 10, 2014, the disclosure of which is incorporated herein by reference.

### FIELD OF THE INVENTION

The present invention relates to a device for controlling a graphic interface and a related method.

### BACKGROUND INFORMATION

It is believed to be understood in the related art that one may provide a fixed connection between a graphic interface and an application based on a data pool, which carries out the communication between the graphic display unit and the application. The data included in the data pool are project-specific and customer-specific, so that a fixed connection results between the user interface and the application. In this method, subsequent changes cannot be made in the graphic control of the user interface and the application during the running time of the graphic user interface.

### SUMMARY OF THE INVENTION

It is an object of the present invention to provide an improved device for controlling a graphic user interface and to provide a method for controlling a graphic user interface.

This object is attained by the device according to the description herein and by the method according to the description herein.

One advantage of the device described is that the graphic user interface is able to be supplied flexibly with data from various data sources. Consequently, it is possible to connect the user interface as a function of a desired function, for example, or as a function of a desired content, to one or more data sources, and to display the data of the data source on the graphic user interface. In addition, during a display of a use or application on the user interface, the user interface is able to access data of different data sources. Data from different data sources may be utilized by the user interface, for instance. This makes for an increased flexibility when one is utilizing data from different data sources. That data source may be selected, for example, which delivers the better or the more current data. The data source may be configured in the form of at least one application.

In a further specific embodiment, a first interface is configured to carry out a message handler function in such a way that, via a connection while using a WebSocket data protocol, messages having a message handler function of the graphic user interface are able to be exchanged.

In a further specific embodiment, a second interface has a callback function. With that, the processing of a message that has been transmitted by the user interface to the processing unit, and passed on by the processing unit to a data source, is able to be processed asynchronously to the function of the processing unit and answered.

In a further specific embodiment, a second interface has a service-client function. With that, access is flexibly made to different data sources.

In one further specific embodiment, the second interface is configured in order to set up a communication between a message handler function and a web service function, using the call back function and/or using the dynamic call interface.

In another specific embodiment, the processing unit is configured to route on the message of the user interface, as a function of the content of the message, to one of at least two data sources. In that way a flexible connection of the data sources is possible. For instance, the message is able to have an address of a receiver (end point). Consequently, the message is sent to the addressed end point.

In a further specific embodiment, the processing unit is configured in order to route on the message of the user interface as a function of at least one parameter of two data sources to one of the two data sources. This makes for achieving an increased flexibility when one is utilizing data sources.

In a further specific embodiment, the processing unit is configured in order to route on the message of the user interface as a function of an external parameter of two data sources to, one of the two data sources. Consequently, for example, by specifying a control parameter from the outside, such as by the input of a user, one of two data sources may be selected.

In one additional specific embodiment, the second interface has a web service function, vis which messages are able to be exchanged with a data source. The web service function represents a simple and flexible configuration for connecting various data sources to the processing unit.

The present invention is explained in greater detail below.

### BRIEF DESCRIPTION OF THE DRAWINGS

FIG. 1 shows a schematic representation of the configuration of the device.

FIG. 2 shows a second detailed representation of the configuration of the device.

FIG. 3 shows a schematic representation of function calls.

FIG. 4 shows a schematic representation of a first program run of the message handler function of the GUI.

FIG. 5 shows a schematic representation of an additional program run of the message handler function of the GUI.

### DETAILED DESCRIPTION

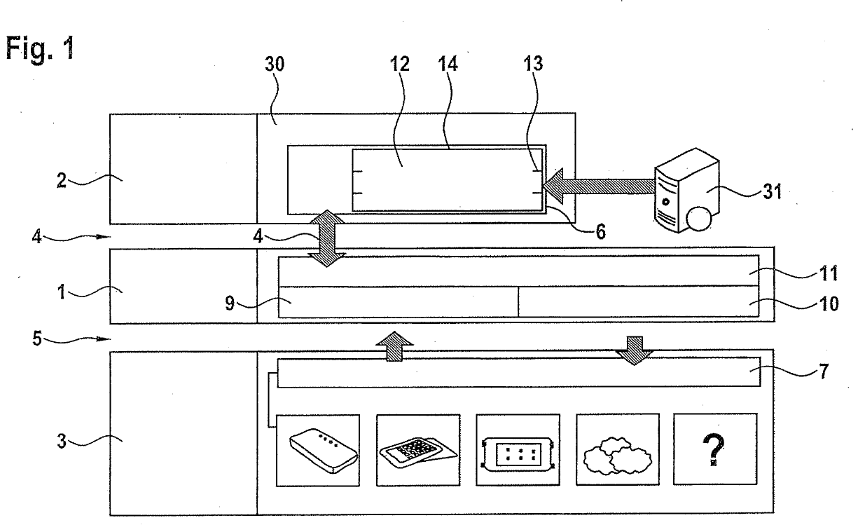

In a schematic representation, FIG. 1 shows a system having a device 1 having a processing unit which is situated between a graphic user interface 2 and one or more data sources 3. User interface 2 is able to be displayed on a display unit 30. Device 1 has a first interface 4 using which device 1 is able to set up a connection to user interface 2. In addition, device 1 has a second interface 5 using which device 1 is able to set up a connection to data source 3. User interface 2 has an additional first interface 6, which is assigned to first interface 4 of device 1. Data source 3 has an additional second interface 7, which is assigned to second interface 5 of device 1. One of several data sources 3 may be contacted via additional second interface 7. As data source 3, for instance, a smart phone, a tablet PC, a head unit, a server or a data cloud may be provided.

Processing unit 1 may be configured in the form of a computing unit, especially in the form of a server. Processing unit 1 has an operating system for processing the programs and functions. In addition, the operating system is able also to transmit messages to the GUI via interface 4. Processing unit 1 has a table in which there is stored which GUI message is to be processed in which way, particularly to which receiver the message is to be passed on.

Processing unit 1 may be configured to route a message of the user interface, for instance, as a function of content of the message, further to one of two available data sources 3. In addition, the processing unit 1 may be configured in order to route on the message of the user interface as a function of at least one parameter of two available data sources, to one of the two data sources. Furthermore, processing unit 1 may be configured to route a message of the display unit as a function of an external control parameter on to one of two available data sources.

The processing unit may be implemented in the form of a software program, or in the form of a computing unit. In addition, the interfaces may be configured in the form of hardware circuits and/or software programs. The graphic user interface may be configured in the form of software programs and/or in the form of a hardware circuit. The graphic user interface may be controlled by the processing unit and processed as a software program. In addition, the graphic user interface may be provided by another computing unit 31, particularly another server.

In the following text, by a callback function one should understand a function with which a server is able to start an operational call of an object in a client. Callback functions make it possible for a server to send data to a client, without the client having explicitly requested the information.

In the following, by a dynamic interface (dynamic invocation interface, DII.) one should understand an interface which is used as a service client. With that, the dynamic interface also makes possible the intervention in otherwise statically determined runs. The dynamic interface makes available the complete functionality, in order to be able to construct and carry out requests dynamically at the running time.

In the following, by message handler one should understand a software program or a function for sending, receiving, switching and for processing messages between distributed software programs or software components. A message is a formalized information which is exchanged between various communications partners within a technical system. A message has a sender and at least one receiver.

In the following, by web service function one should understand a software program or a function which is configured to support a collaboration between machines via a network. The web service program has an interface which is described in a machine-readable format, such as WSDL. Other embodiments work together with the web service program with the aid of SOAP messages, typically utilizing HTTP in connection with other network standards.

By a WebSocket protocol one should understand a network protocol based on TCP, which was drawn up in order to produce a bidirectional connection between a network application and a network socket server or web server which also supports WebSockets.

Additional second interface 7 may be configured, for instance, in order to be able to communicate with a web service function 16. Data sources 3 are able to provide applications. The applications may be programmed, for example, in Java, C++ or in another programming language. Applications are able to provide graphic interfaces, for example.

Second interface 5 may have a callback interface function 9, for example, for receiving messages. In addition, second interface 5 may have a dynamic interface (dynamic invocation interface function) 10 for outputting messages. In addition, callback function 9 and dynamic interface 10 may communicate with a message handler function 11. Message handler function 11 may be a part of first interface 4.

User interface 2, as a further interface 6, may have an additional message handler function 12, particularly a GUI message handler function. In addition, the additional message handler function 12 may be in connection with a control function 13. Moreover, control function 13 may be in connection with a presentation function 14. Additional message handler function 12, control function 13 and presentation function 14 may be configured in the form of a client function, particularly in the form of a web application. Control function 13 controls, for example, the sequence of the representation of graphic user interface 2, as a function of the inputs of a user. Presentation function 14 may have a layout function which is programmed in HTML, for instance. In addition, presentation function 14 may have a style function which is programmed in CSS, for example. Presentation function 14 determines the visible data of GUI 2, such as the layout, the color, the position, the text, the graphic representation, a widget, etc. Control function 13 may be programmed in JS. In addition, message handler function 12 may be programmed in JS.

Furthermore, the additional message handler function 12 may be in connection with message handler function 11 via a WebSocket protocol. Message handler function 11 is programmed as a servlet.

Callback function 9 is programmed in the form of Java classes, for example. Web service function 16 is in connection with applications of at least one data source 3, particularly with a native application of data source 3. Web service function 16 may also be in connection with a plurality of applications of one or more data source 3, particularly with native applications of a plurality of data sources 3. On GUI server 31, GUI 2 is able to be available for download and for rendering by a browser.

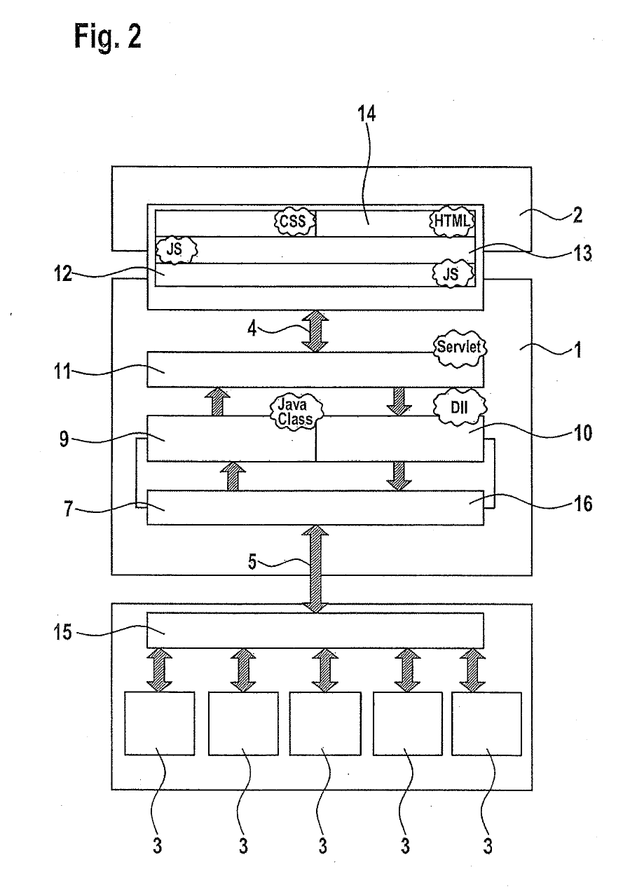

In a detailed representation, FIG. 2 shows the subdivision of the system into three planes. The first plane is formed by graphic user interface 2. The illustration of graphic user interface (GUI) 2 takes place on a display with the aid of a browser of a display unit, such as a head unit or a smart phone. While layout elements and design elements of GUI 2 are able to be implemented using HTML and CSS, logic elements 13 and the further message handler function 12, which is used as an interface for communication between GUI 2 and processing unit 1 particularly for a server, is implemented in each case using Java script.

The second plane is formed by processing unit 1 in the form of a server, for example, which is used as a switching component for linking GUI 2 to a native application 15 of a data source 3. A native application is an application which actually runs on data source 3 and is not implemented by a virtual application. By a virtual application one may understand an application which is formed from individual functions, the functions being provided by different applications via a web service. A message handler function 11, which runs on processing unit 1, reproduces the received GUI messages, system messages or web service messages to form a new message to a receiver. This receiver may be a GUI 2, the operating system or a native application, i.e. a web service function 16. Before sending, a partitioning of the message may take place, before the message is transmitted directly to a receiver or, via a network, to a plurality of receivers.

Web service function 16 is used as an interface for providing the functionalities of native applications 15. The call of native applications 15 may take place asynchronously, for instance with the aid of a SOAP protocol and using a reliable message transmission. The asynchronous nature of the call makes it possible not to have to wait explicitly for the response of web service function 16. In the case of the reliable message transmission, the receipt of a message is in each case acknowledged by sending a confirmation message to the sender. In the case of a loss of a message, the transmission of the message is repeated.

A dynamic interface (dynamic invocation interface) is responsible for the call, which is informed by message handler function 11 by processing unit 1 via the web service method to be called.

The result of a call of web service function 16 is passed, based on the asynchronous call, to a callback function 9, which routes the received message on to message handler function 11 of processing unit 1. In the same way, linked web service functions are in a position, autonomously on their own initiative to send a notification to a central web service function 16 that is implemented on processing unit 1. Web service function 16, in turn, routes the message to the message handler function 11 of processing unit 1.

The third plane is used for providing the application via a service provider. Data sources 3 have native applications 15, which make available their functions to be provided via an interface as web service function 16. For this, data sources 3 make known an interface description of the native applications, in WSDL format. A call takes place, e.g. with the aid of messages, for instance, in XML format, for instance, via a standard web protocol, such as HTTP or SMTP. The implementation of the native application itself is therefore independent of the platform and of the programming language of processing unit 1 or GUI 2. The service provider may physically be stored on processing unit 1 or even physically separated, on an additional server.

During the interaction of a user with GUI 2, a corresponding GUI message is generated, which is routed on to the correct receivers by GUI message handler function 12. Receivers may be either additional GUI elements or system components or virtual applications on processing unit 1, such as a media player. GUI messages determined to be for processing unit 1 are sent to message handler function 11. GUI messages that are to be processed in GUI message handler function 12 may be unicast messages, multicast messages or broadcast messages. A message is designated as a unicast message if the message is directed to only one receiver. A message is designated as a multicast message if the message is directed to at least two receivers, but not to all available receivers. A message is designated as a broadcast message if the message is directed to all available receivers. A receiver may be a GUI 2 or an application of a GUI, an operating system or a native or virtual application.

In one processing process the GUI messages are split up into unicast, multicast or broadcast messages, so that messages having only one receiver are able to be delivered on the GUI plane directly as unicast, while messages to message handler 11 of processing unit 1 are sent out as a new multicast. The use of one GUI message handler function 12 in each case on GUI 2, and a message handler function 11 on the side of processing unit 1, as well as the processing processes of the messages implemented on both sides leads to a clear reduction in the messages to be sent via interface 4, and to a gain in performance connected to it.

The communication between additional message handler 12 of GUI 2 and message handler function 11 of processing unit 1 takes place via a bidirectional full duplex connection, which supports an asynchronous communication. An exemplary implementation is possible with the aid of the WebSocket protocol. Messages sent by further message handler function 12 of GUI 2 are accepted by message handler function 11. If a multicast or a broadcast message is involved, the message is split up accordingly. Consequently, the number of messages to be transmitted remains minimal.

The implementation of the components of processing unit 1, particularly of server components, takes place in Java, for example. Message handler function 11 may be converted as servlet classes into Java, the additional server components being able to be converted as simple Java classes. The server is set up on a server runtime, (e.g. Apache Tomcat). The dynamic interface (dynamic invocation interface) is able to be implemented in Java. In addition, the callback function and the dynamic interface are based on a web service runtime, such as Axis 2 runtime.

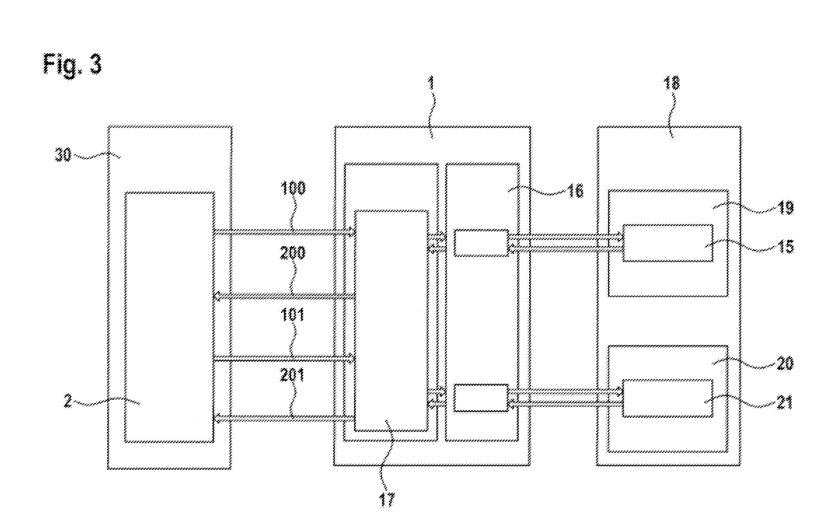

FIG. 3 shows a runtime model of a link of a display unit 30 to a graphic user interface (GUI) 2 to distributed native applications 15, 21 with the aid of a virtual application 17, which runs on a processing unit 1, particularly a server. Virtual application 17 reproduces detailed functional calls of GUI 2 to functions of linked native applications 15, 21. In the example, an interaction process between a functional call of GUI 2 by an input of an operator to a functional call and a functional return to a GUI update is shown in exemplary fashion, having two sources 19, 20 having native applications. GUI 2 sends a GUI message 100 to server 1. In server 1 a virtual application 17, e.g. in the form of a media player, is being run. Virtual application 17 fetches the required data and items of information via a web service 16 of a native application 15, which is running at a service provider 18 on a first server 19. Virtual application 17 passes on the data via a response message 200 to GUI 2.

In the same way, an additional message 101 of GUI 2 is fetched by media player 17 via web service 16 from an additional native application 21 by a second server 20 and is returned to the user interface as a further response message 201. Instead of the first or second server, a head unit or a data cloud may be provided, for example, which act as a server, the native applications running on the head unit or the data cloud. Instead of the native applications, virtual applications could also be provided again.

The GUI messages sent to server 1 by GUI 2 are reproduced by message handler function 11 of server 1 to a system functionality such as a file system access or to a functional call of a linked native application. The functions of the linked native applications are combined to individual, abstract units, the virtual applications 17, which are able to be addressed by the GUI 2.

For this, each virtual application 17 has a clearly defined interface, which is known to GUI 2, and which is able to call GUI 2 using messages, to the message handler function 11 of server 1. In message handler function 11 there subsequently takes place the reproduction to functional calls of the linked web service function. The functions of an individual virtual application 17 in server 1, may be reproduced, in this context, to functions of different web service functions 16 and/or to functions of different native applications 15, 21. Based on this abstraction on server side 1, from the point of view of GUI 2, there takes place the communication only with virtual application(s) 17 of the message handler function 11 of server 1. Native applications 15, 21 lying behind them are not visible to GUI 2.

The device described and the method described may be converted, for example, for head units or instrument clusters in a motor vehicle particularly as an HTML5-based HMI solution.

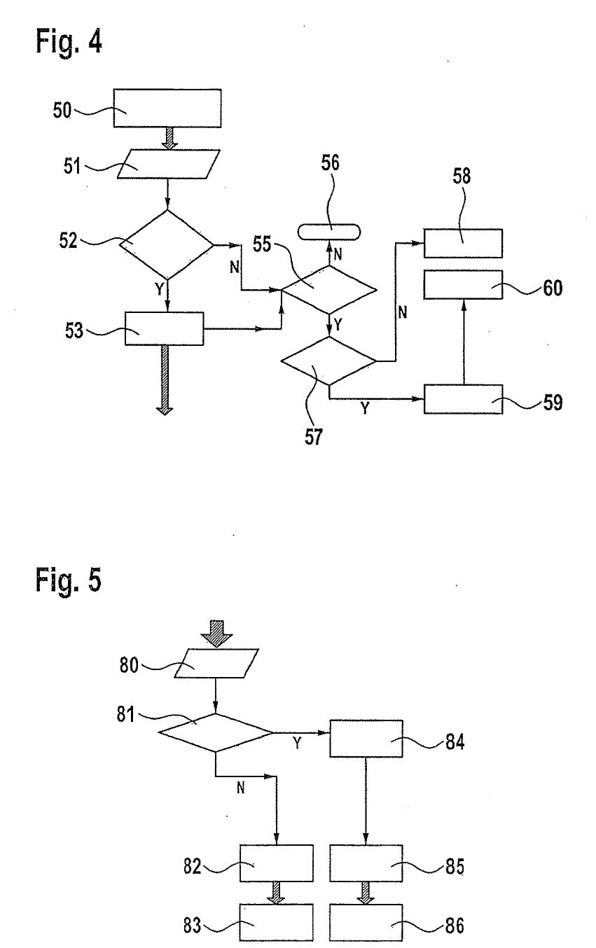

FIG. 4 shows a schematic representation of a program sequence for the treatment of a user input into GUI 2. The input may take place via an input unit such as a computer mouse, a keyboard or a touchscreen. A user is able to produce a user reaction by an appropriate input in GUI 2 at program point 50, which is recorded at a program point 51 by a controller 13 of GUI 2 as an event, and is passed on to message handler function 12 of GUI 2. At a following program point 52, it is checked whether the user interaction is relevant for a functional call of an application. If this is the case, the program branches to program point 53. At program point 53, an appropriate message is set up as a function of the input. The message includes the sender, that is, GUI 2 or a GUI application, of which the input of the user was recorded. In addition, the message includes a useful information which states which information or data are desired, based on the input. In addition, the message may include the receiver, by whom the useful information is to be delivered. The message is routed on to the message handler function 11 of server 1. If the message is also interesting for GUI 2 and the GUI application, the message is routed on at program point 55 and is processed further at program point 55.

If the inquiry at program point 5.2 yields that the user input is not relevant for a functional call of an application, the program branches to program point 55. At program point 55 the inquiry takes place as to whether the user input is relevant for a GUI 2. If this is not the case, the program branches to program point 56, and the user input is ignored. If the inquiry at program point 55 yields that the user input is relevant for the function of GUI 2, the program branches to program point 57. At program point 57 it is checked whether the user input is to be routed on to a single GUI 2 or to a plurality of GUI's 2. As a function of the selected embodiment, a plurality of GUI's may be provided. If the user reaction is to be routed on only to one GUI 2, this is transmitted at program point 58 of the corresponding GUI 2 and the GUI 2 is correspondingly adjusted.

If the checking at program point 57 yields that the user input is to be transmitted to a plurality of GUI's 2, the program branches to program point 59. At program point 59, a processing process is carried out using the data or the message of the user input. At a following program point 60, the data or the message of the user input are routed on to the plurality of GUI's.

FIG. 5 shows a schematic representation of a message which at program point 80, is returned by message handler function 11 of processing unit 1, particularly of a server, to GUI message handler 12 of GUI 2 as response to an inquiry. At a following program point 81, it is checked whether the message is to be routed on to a certain GUI 2 or to a plurality of GUI 2's. If the result at program point 81 yields that the message is only provided for one GUI 2, the message is passed on at a following program point 82 to logical control function 13 of GUI 2. The message received from GUI 2 is taken into account subsequently at a following program point 83 for the illustration of a graphic representation.

If the inquiry at program point 81 yields that the information is meaningful to a plurality of GUI's 2, the program branches to program point 84. A processing process of the message takes place at program point 84. The processed message is subsequently, at a following program point 85, transmitted to the various GUI's 2. For this purpose, the processed message is passed on to the logical control unit of the GUI. At a following program point 86, GUI's 2 take into account the message received in the graphic representation, or display the message.

Message handler function 11 and further message handler function 12 are responsible for the data exchange between GUI 2 and the native applications. Message handler function 11 and further message handler function 12 are responsible for the setup of the data connection, the content of the data connection and the addressing of the data connection. For this purpose, messages are exchanged which have useful information, a specification of a sender and a specification of a receiver. As sender and receiver, an application, i.e. a web service function, a GUI and the operating system may each be provided, which are able the send messages to one another, in order to request a response having a useful information.

The system described may be situated in a vehicle, for example, the display unit having the operator interface and the processing unit being situated in the vehicle. The data sources may be situated in the vehicle, but also outside the vehicle. For instance, the processing unit is able to access a data source via an Internet connection. The data sources may be situated in one unit or in a plurality of different units. The system may, for instance, be an infotainment system of a vehicle, which is able to offer the user data, music, pictures, movies and items of information from various sources via the graphic operator interface.

What is claimed is:

1. A device for controlling a graphic user interface of a display unit, comprising:
a first interface;
a processing unit; and
a second interface;
wherein the first interface is configured to transmit a message of the user interface to the processing unit,
wherein the processing unit is configured to send the message via the second interface to at least one data source,
wherein the second interface is configured to receive a response message from the data source, and
wherein the processing unit is configured to route on the response message via the first interface to the user interface.

2. The device of claim 1, wherein the processing unit is configured to route on the message of the user interface as a function of the content of the message, particularly as a function of an address of a receiver, to one of at least two data sources.

3. The device of claim 1, wherein the processing unit is configured to route on the message of the user interface as a function of at least one parameter of two data sources to one of the two data sources.

4. The device of claim 1, wherein the processing unit is configured to route on the message of the user interface as a function of an external control parameter to one of two data sources.

5. The device of claim 1, wherein the processing unit is configured to embody the first interface in the form of a message handler function.

6. The device of claim 1, wherein the second interface is configured to carry out a callback function.

7. The device of claim 1, wherein the second interface is configured to carry out a dynamic interface function.

8. The device of claim 1, wherein the second interface has a web service function via which messages are able to be exchanged with a data source.

9. The device of claim 1, wherein the first interface is configured to exchange a message between a message handler function of the user interface and a message handler function of processing unit via a WebSocket protocol.

10. The device of claim 1, wherein the processing unit has a computing unit which provides a server.

11. The device of claim 10, wherein a program for the graphic user interface is run on the processing unit.

12. The device of claim 1, wherein the device is installed in a motor vehicle, and wherein the data sources are situated in the vehicle or outside the vehicle.

13. A method for controlling a graphic user interface of a display unit, having a first interface, having a processing unit, having a second interface, the method comprising:
transmitting via the first interface a message of the user interface to the processing unit;
sending via the processing unit the message via the second interface to at least one data source;
receiving via the processing unit a response message from the data source via the second interface; and
routing on, via the processing unit, the response message via the first interface to the user interface.

14. The method of claim 13, wherein the processing unit routes on the message of the user interface as a function of the content of the message or as a function of at least one parameter of the two data sources or as a function of an external control parameter to one of two data sources.

15. The method of claim 13, wherein the first interface includes a message handler function.

16. The method of claim 13, wherein the second interface includes a callback function.

17. The method of claim 13, wherein the second interface includes a service client.

18. The method of claim 13, wherein the second interface includes a web service function, via which messages are exchanged with a data source.

19. The method of claim 13, wherein the first interface exchanges a message between a message handler function of the user interface and a message handler function of the processing unit via a WebSocket protocol.
